(19) United States
(12) Patent Application Publication
(10) Pub. No.: US 2025/0313039 A1
(43) Pub. Date: Oct. 9, 2025

(54) AXLE SHAFT TRANSPORT RETENTION SPACER

(71) Applicant: Dana Heavy Vehicle Systems Group, LLC, Maumee, OH (US)

(72) Inventors: Steven G. SLESINSKI, Vicksburg, MI (US); Stan KIELAR, Maumee, OH (US)

(21) Appl. No.: 18/626,136

(22) Filed: Apr. 3, 2024

(51) Int. Cl. B60B 35/00; B60B 37/00

(52) U.S. Cl. CPC B60B 35/004; B60B 37/00; B60B 2900/531; B60B 2900/541

(57) ABSTRACT

Described herein is an axle shaft transport retention spacer for use in an axle assembly of a vehicle. In one embodiment, the axle shaft transport retention spacer comprises a first portion and a second portion configured to be selectively coupled to each other, and a center bore that extends through the first portion and the second portion and that is configured to circumferentially surround an axle shaft.

### TECHNICAL FIELD

The present description relates generally to an axle assembly of a vehicle.

### BACKGROUND AND SUMMARY

Axle assemblies are adapted to transmit rotational power from a rotational power source of a vehicle to the wheels thereof. Typically, an axle assembly includes a differential assembly that is rotatably supported within a non-rotating housing (e.g., a carrier). The differential is connected between an input drive shaft extending from the rotational power source and a pair of output axle shafts extending to the vehicle wheels. The output axle shafts are housed in respective non-rotating beam housing portions, which are secured to a central non-rotating carrier. Thus, rotation of the differential by the input drive shaft causes corresponding rotation of the axle shafts. The central non-rotating carrier and the beam housing portions form an axle housing for these drive train components of the axle assembly, with the differential and the axle shafts supported for rotation therein.

A vehicle, such as a truck, may be transported by a transport vehicle by coupling the vehicle to the transport vehicle, and using the transport vehicle to tow the vehicle in such a way that the vehicle is not moved under its own power (e.g., the rotational power source of the vehicle may not provide rotational power). Some methods for towing a vehicle demand removal of one or more axle shafts from the axle assembly. Removal of axle shafts prevents rotational power from being translated along a respective axle shaft to the differential, the electric machine, and/or other elements of the axle assembly in a direction opposite that of an operational power flow. For example, if the axle shafts are engaged with the differential during towing, rotational power from drive wheels that are in contact with the drive surface flows from the drive wheels to the differential via the axle shafts. Removal and storage of axle shafts for vehicle towing is a complex, labor intensive process that increases operating costs and demands packaging space to store the removed axle shafts. Other methods may be desired.

Described herein are systems and methods for vehicle transportation that enable uncoupling of the differential and an axle shaft without removing the axle shaft from the axle assembly. An internal disconnect is selectively implemented in the axle assembly to uncouple the differential from the axle shaft, thus preventing back driving of the differential by drive wheels of the axle shaft while reducing a number of components that are removed from the axle assembly. For example, an axle shaft transport retention spacer comprises a first portion and a second portion configured to be selectively coupled to each other, and a center bore that extends through the first portion and the second portion and that is configured to circumferentially surround an axle shaft. The axle shaft transport retention spacer may be implemented in an axle assembly comprising an axle shaft configured to translate along an axis between a first position and a second position, and a wheel hub selectively coupled to the axle shaft, among other elements. A method for vehicle transportation using the axle shaft transport retention spacer comprises: removing a first set of fasteners that selectively couple a flange of an axle shaft and a wheel hub; laterally translating the axle shaft in a first direction to disengage the axle shaft from a differential; positioning and selectively coupling a first portion and a second portion of the axle shaft transport retention spacer to circumferentially surround the axle shaft between the flange of the axle shaft and the wheel hub; and coupling the axle shaft transport retention spacer to the flange of the axle shaft using the first set of fasteners. Upon arrival to a target destination, the axle assembly may be reassembled by removing the first set of fasteners that selectively couple the axle shaft transport retention spacer to the flange of the axle shaft, uncoupling and removing the first portion and the second portion of the axle shaft transport retention spacer from the axle shaft, laterally translating the axle shaft in a second direction, opposite the first direction, to engage the axle shaft with the differential and with the wheel hub, and coupling the axle shaft to the wheel hub via the first set of fasteners. The systems and methods described herein enable a simplified process for preparing the vehicle for transportation that does not demand management and retention of multiple elements of the axle assembly, and further eliminates demand for axle shafts to be removed and stored for vehicle transport.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a schematic representation of an electric drive system.

FIG. 2 shows a perspective view of an electric drive system, according to one example.

FIG. 3 shows a perspective view of an axle shaft transport retention spacer, according to one example.

FIG. 4 shows a perspective view of a first portion of the axle shaft transport retention spacer.

FIG. 5 shows a first set of perspective views of a first portion and a second portion of the axle shaft transport retention spacer.

FIG. 6 shows a second set of perspective views of the first portion and the second portion of the axle shaft transport retention spacer.

FIG. 7 shows a perspective view of the axle shaft transport retention spacer coupled to a wheel hub.

FIG. 8 shows a perspective view of an electric drive system including two axle shaft transport retention spacers, according to one example.

FIG. 9 shows a flow chart of a method for preparing an axle assembly of a vehicle for vehicle transportation.

FIG. 10 shows a flow chart of a method for reassembly of an axle assembly of a vehicle following vehicle transportation.

### DETAILED DESCRIPTION

The following description relates to systems for a vehicle axle assembly and, specifically, an axle shaft transport retention spacer, also referred to herein as “an axle shaft spacer”, comprising a first portion and a second portion configured to be selectively coupled to each other, and a central bore that extends through the first portion and the second portion and that is configured to circumferentially surround an axle shaft. The axle shaft spacer may be positioned on an axle shaft of the axle assembly prior to transportation of the vehicle (e.g., via towing) to uncouple the axle shaft from a differential of the axle assembly. Rotational motion from wheels mounted on wheel hubs of the axle shaft is thus not transferred to the differential, which may reduce degradation of the differential and other elements of the axle assembly by preventing back driving of the differential during vehicle transport.

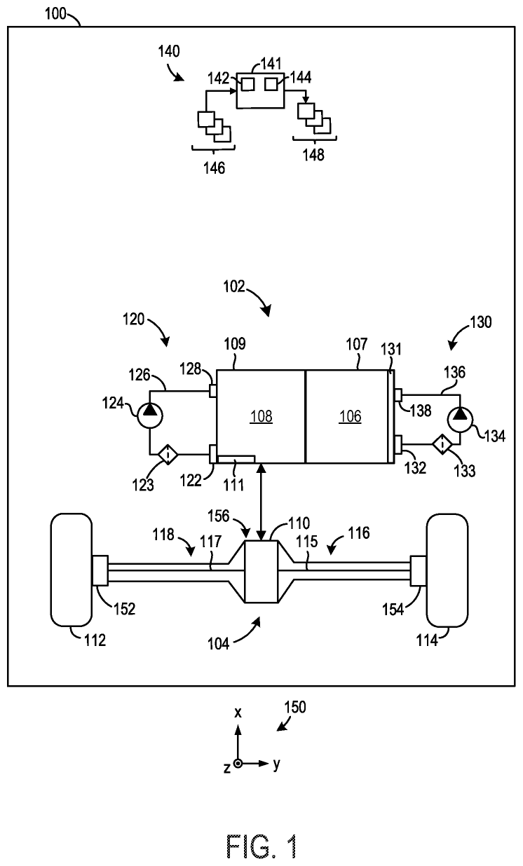

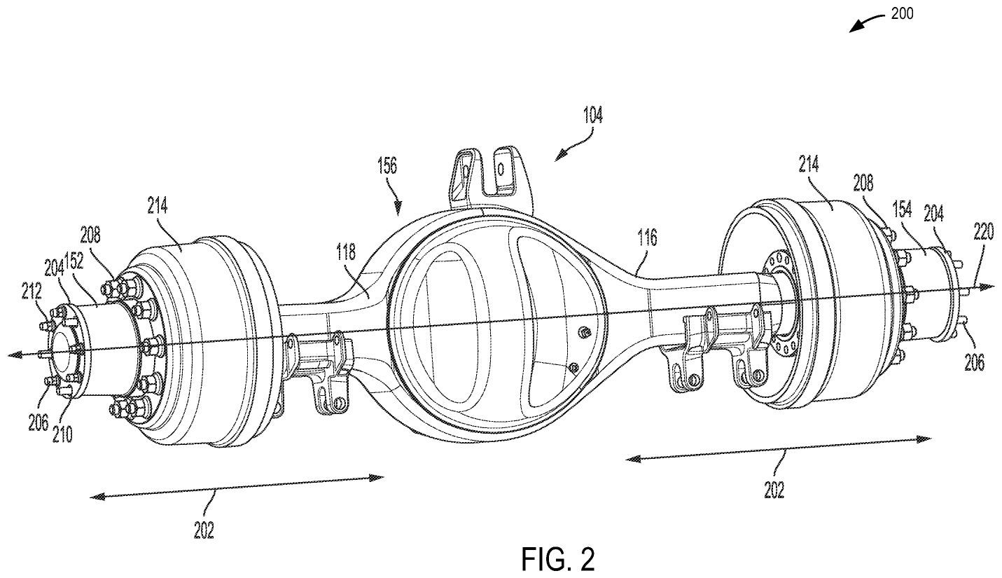

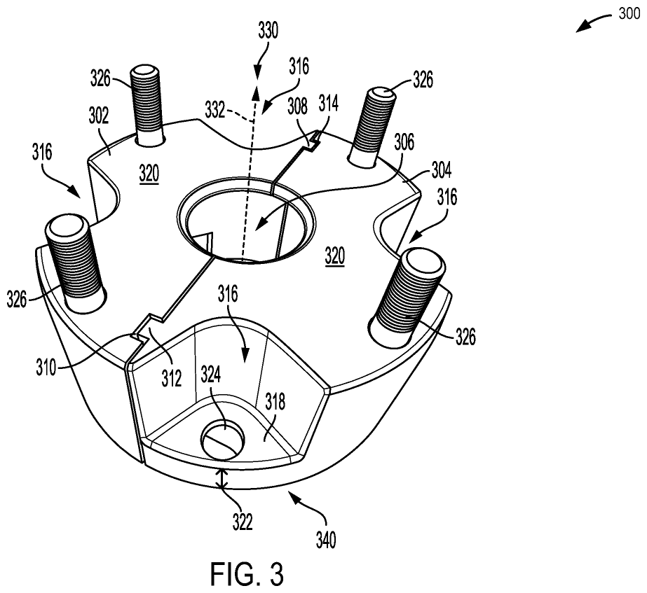

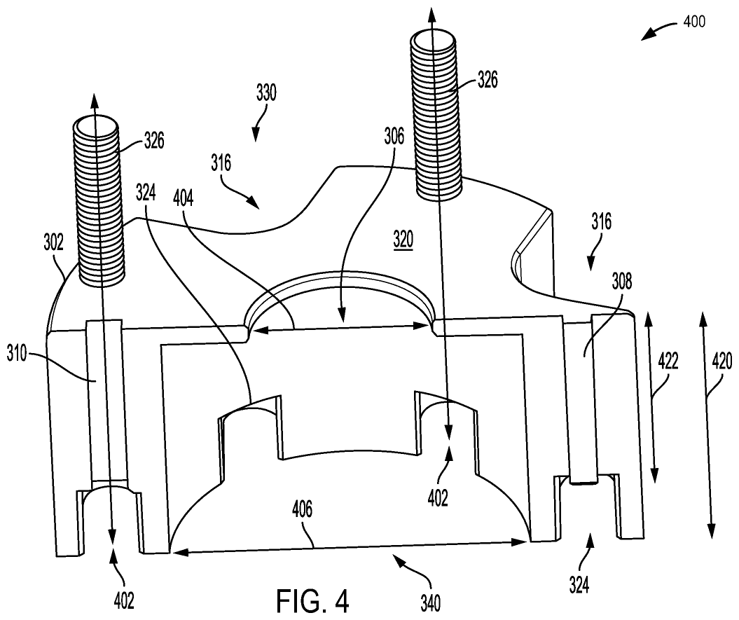

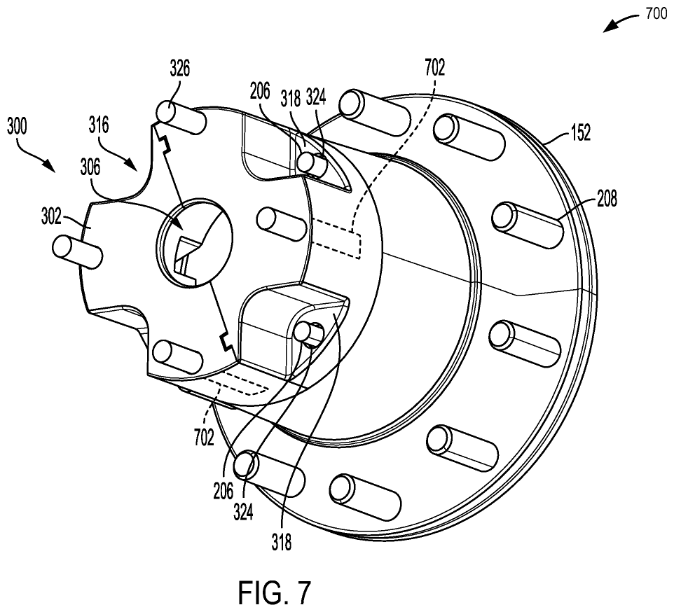

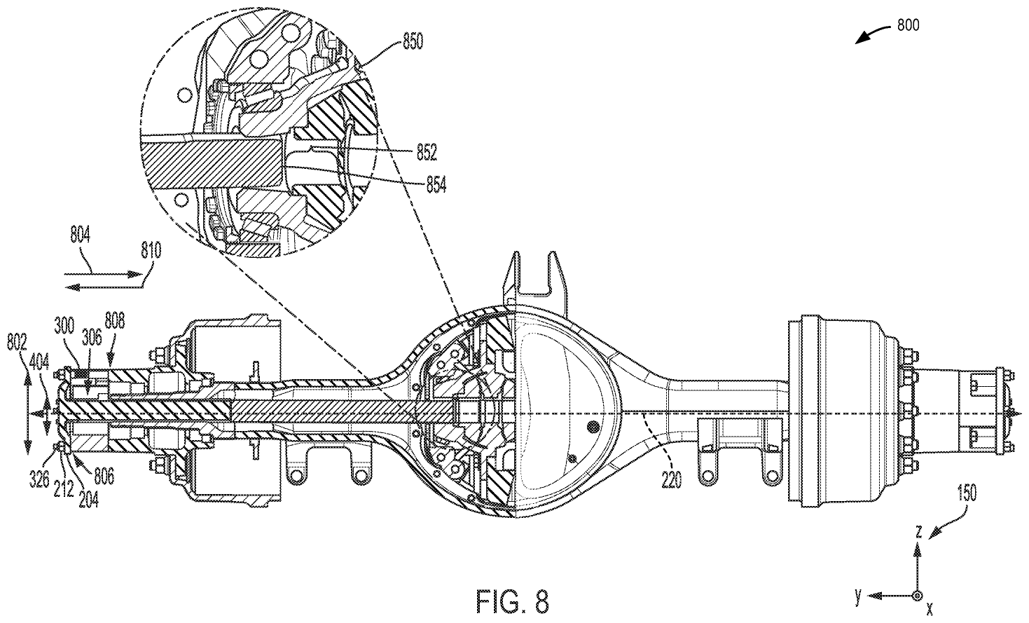

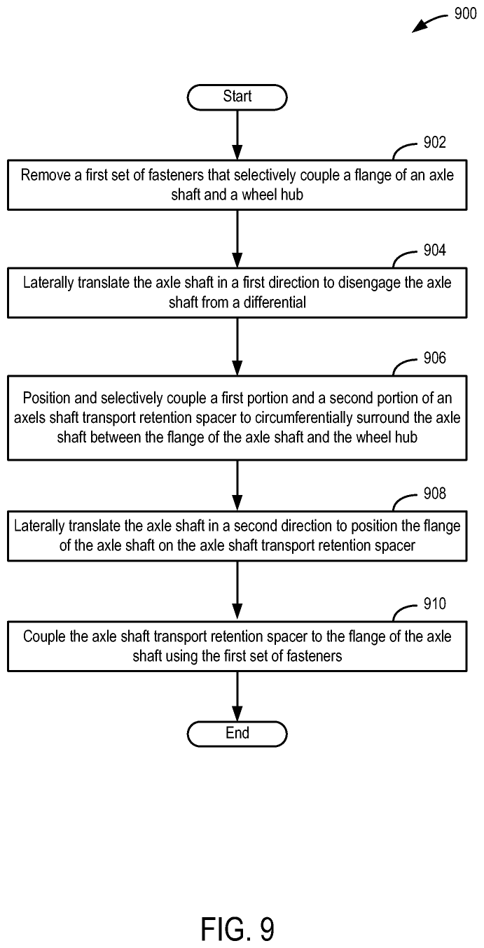

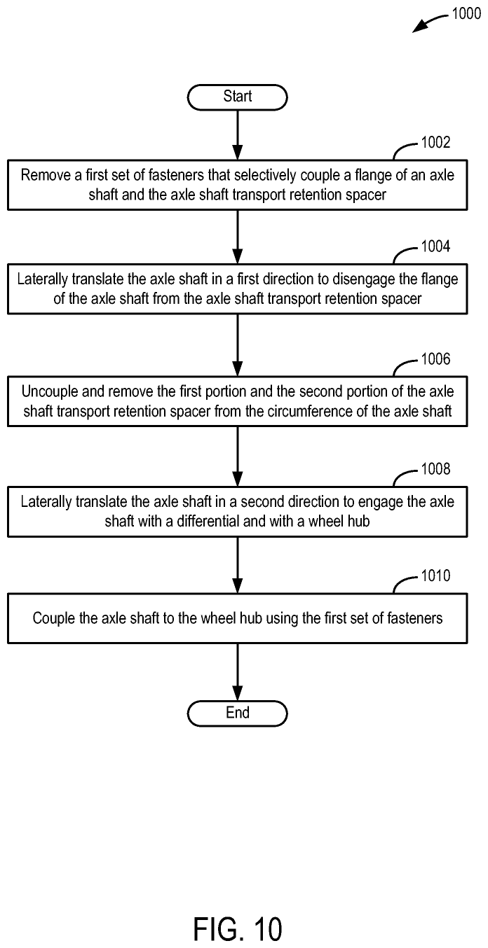

FIG. 1 schematically depicts a drive system, such as an electric drive system, in a vehicle. FIG. 2 shows a perspective view of an axle assembly in a first configuration that may be included in the drive system of FIG. 1. An axle shaft transport retention spacer, an example of which is shown in FIG. 3, may be selectively coupled to an axle shaft of the axle assembly of FIG. 2 prior to and during transportation (e.g., towing) of the vehicle. Examples of a first portion and a second portion of the axle shaft spacer are shown in perspective view of FIGS. 4-6. When positioned to circumferentially surround the axle shaft, the axle shaft spacer may further be coupled to a wheel hub of the axle assembly, as shown in FIG. 7. A perspective view of an axle assembly in a second configuration with the axle shaft spacer positioned thereon to selectively uncouple the axle shaft and the differential is shown in FIG. 8. FIG. 9 shows a flow chart of a method for preparing an axle assembly of a vehicle for vehicle transportation (e.g., transitioning the axle assembly from the first configuration to the second configuration), and FIG. 10 shows a flow chart of a method for reassembly of an axle assembly of a vehicle following vehicle transportation (e.g., transitioning the axle assembly from the second configuration to the first configuration). FIGS. 2-8 are drawn approximately to scale. However, other relative component dimensions may be used, in other embodiments.

FIG. 1 schematically illustrates a vehicle 100 with an electric drive system 102 that provides power to and/or is incorporated into an axle assembly 104 of vehicle 100. The vehicle 100 may take a variety of forms in different examples, such as a light, medium, or heavy duty vehicle. Additionally, the electric drive system 102 may be adapted for use in front and/or rear axles, as well as steerable and non-steerable axles. To generate power, the electric drive system 102 may include an electric machine 106. In some examples, the electric machine 106 may be an electric motor-generator and may thus include conventional components such as a rotor, a stator, and the like housed within an electric machine housing 107 for generating mechanical power as well as electric power during a regenerative mode, in some cases. Further, in other examples, the vehicle 100 may include an additional motive power source, such as an internal combustion engine (ICE) (e.g., a spark and/or compression ignition engine), for providing power to another axle. As such, the electric drive system 102 may be utilized in an electric vehicle (EV), such as a hybrid electric vehicle (HEV) or a battery electric vehicle (BEV).

In some examples, the electric machine housing 107 may be coupled (e.g., via bolts) to a gearbox housing 109 of a gearbox 108. Further, the electric machine 106 may provide mechanical power to a differential 110 via the gearbox 108. From the differential 110, mechanical power may be transferred to drive wheels (e.g., a first wheel 112, a second wheel 114) by way of a first axle shaft 117 and a second axle shaft 115, respectively, of the axle assembly 104. For example, the first wheel 112 may be mounted on a first wheel hub 152 that is selectively coupled to the first axle shaft 117 such that rotation of the first axle shaft 117 may drive rotation of the first wheel hub 152 and the first wheel 112. The second wheel 114 may be mounted on a second wheel hub 154 that is selectively coupled to the second axle shaft 115 such that rotation of the second axle shaft 115 may drive rotation of the second wheel hub 154 and the second wheel 114. As such, the differential 110 may distribute torque, received from the electric machine 106 via the gearbox 108, to the first wheel 112 and the second wheel 114 of the first axle shaft 117 and the second axle shaft 115, respectively, during certain operating conditions. In some examples, the differential 110 may be a locking differential, an active or passive limited slip differential, or a torque vectoring differential. One or both of the first axle shaft 117 and the second axle shaft 115 may be housed in an axle housing. For example, the first axle shaft 117 is housed in a first axle housing 118, and the second axle shaft 115 is housed in a second axle housing 116. Each of the first axle housing 118 and the second axle housing 116 may have the same configuration. Further, the first axle housing 118 and the second axle housing 116 may be coupled to and/or continuous with a central housing 156 in which the differential 110 is housed.

The gearbox 108 may be a single-speed gearbox, where the gearbox 108 operates in one gear ratio. However, other gearbox arrangements have been envisioned such as a multi-speed gearbox that is designed to operate in multiple distinct gear ratios. Further, in one example, the electric machine 106, the gearbox 108, and the differential 110 may be incorporated into the axle 104, forming an electric axle (e-axle) in the vehicle 100. The e-axle, among other functions, provides motive power to the first wheel 112 and the second wheel 114 during operation. Specifically, in the e-axle embodiment, the electric machine 106 and gearbox 108 may be coupled to and/or otherwise supported by the first axle housing 118 and the second axle housing 116. The e-axle may provide a compact arrangement for delivering power directly to the axle 104. For example, the first axle housing 118 may be coupled to a first side of the gearbox housing 109 and the second axle housing 116 may be coupled to a second side of the electric machine housing 107, opposite the first side.

The electric drive system 102 may further include an oil circuit 120 for circulating oil (e.g., natural and/or synthetic oil) through the gearbox housing 109 to lubricate and/or cool various system components. The oil circuit 120 may include a filter 123 and an oil pump 124 that draws oil from an oil reservoir 111 (e.g., a sump) in the gearbox housing 109, via an outlet 122, and drives a pressurized oil flow through a delivery line 126 to an inlet 128 of the gearbox housing 109. In some examples, the oil pump 124 may be provided at an exterior portion of the gearbox housing 109. However, in other examples, the oil pump may be included within the gearbox housing 109. Various distribution components and arrangements (e.g., nozzles, valves, jets, oil passages, and the like) of the oil circuit 120 may be included within the electric drive system 102 in order to facilitate routing of the oil within the gearbox housing 109 and, in one particular example, to a portion of the electric machine housing 107. In some case, the oil circuit 120 may be used for routing oil to various gearbox bearings and gears as well as the motor stator, motor rotor, and rotor shaft bearings of the electric machine 106, thereby providing an efficient system for effectively using the gearbox oil to cool said systems. In some embodiments, the oil circuit 120 may further include a heat exchanger (e.g., radiator) which removes heat from the oil that exits the gearbox housing 109 by way of the outlet 122.

The electric drive system 102 may further include a coolant circuit 130 that circulates coolant (e.g., water, glycol, and/or oil) through coolant passages 131 formed in the electric machine 106 or electric machine housing 107. The coolant circuit 130 may include a coolant inlet 138 and a coolant outlet 132 positioned on (or in) the electric machine housing 107. The coolant circuit 130 may further include a filter 133 and a pump 134 that circulates coolant from the coolant outlet 132 to the coolant inlet 138 via a coolant delivery line 136. From the coolant inlet 138, the coolant travels into the coolant passages 131 formed in the electric machine 106 or the electric machine housing 107 which removes heat from components of the electric machine 106. In some examples, the coolant circuit 130 may further include a heat exchanger (e.g., radiator) which removes heat from the coolant that exits the electric machine housing 107 by way of the coolant outlet 132.

The vehicle 100 may also include a control system 140 with a controller 141. The controller 141 may include a processor 142 and a memory 144. The memory may hold instructions stored therein that when executed by the processor cause the controller 141 to perform various methods, control techniques, and the like described herein. The processor 142 may include a microprocessor unit and/or other types of circuits. The memory 144 may include known data storage mediums such as random access memory, read only memory, keep alive memory, combinations thereof, and the like. The controller 141 may receive various signals from sensors 146 positioned in different locations in the vehicle 100 and electric drive system 102. The controller 141 may also send control signals to various actuators 148 coupled at different locations in the vehicle 100 and electric drive system 102. For instance, the controller 141 may send command signals to the oil pump 124 and/or the pump 134 and, in response, the actuator(s) in the pump(s) may be adjusted to alter the flowrate of the oil and/or coolant delivered therefrom. In other examples, the controller may send control signals to the electric machine 106, and in response to receiving the command signals, the electric machine may be adjusted to alter a rotor speed or torque. The other controllable components in the system may be operated in a similar manner with regard to sensor signals and actuator adjustment.

An axis system 150 is provided in FIG. 1, as well as FIGS. 2-8, for reference. The z-axis may be a vertical axis (e.g., parallel to a gravitational axis), the x-axis may be a longitudinal axis (e.g., horizontal axis), and/or the y-axis may be a lateral axis, in one example. However, the axes may have other orientations, in other examples.

FIG. 2 shows a perspective view 200 of a first configuration of the axle assembly 104 of FIG. 1. The first configuration that may be used when the vehicle 100 is in a self-propelled driving mode (e.g., is not being towed or transported by another vehicle). As described with respect to FIG. 1, the first axle shaft 117 is housed in the first axle housing 118 and the second axle shaft 115 is housed in the second axle housing 116, respectively, and the axle shafts are thus not visible in FIG. 2. The first axle shaft 117 and the second axle shaft 115 each extend a respective length 202 from the differential 110 (not visible in FIG. 2, housed in the central housing 156) to a respective wheel hub (e.g., the first wheel hub 152, the second wheel hub 154). The first axle shaft 117 and the second axle shaft 115 each comprise a flange 204 of the axle shaft at an end of the axle shaft opposite the differential 110. The flange 204 may be configured as a disc, a dome, or another circular shape that is coupled to and has a greater diameter than a diameter of the axle shaft along the respective length 202. In other examples, the flange 204 may have a different shape (e.g., rectangular, trapezoid, etc.). The flange 204 may be configured with a plurality of through holes 210 configured to receive coupling elements, such as bolts or other coupling extensions. For example, and as further described herein, bolts 206 of the wheel hub and/or coupling extensions of an axle shaft spacer may extend through the through holes 210 of the flange 204. A first set of fasteners 212 may be selectively coupled to coupling elements that extend through the plurality of through holes 210 of the flange 204 to couple the flange 204 to a respective element (e.g., the wheel hub and/or the axle shaft spacer). In the example of FIG. 2, fasteners of the first set of fasteners 212 are shown on some of the bolts 206 for illustrative purposes, and it is to be understood that the first set of fasteners 212 may include fasteners on some or all of the bolts 206 in different examples.

The first axle shaft 117 and the second axle shaft 115 are each configured to translate along an axis 220 between a first position and a second position. The axle shaft is shown in the first position in FIG. 2, where each axle shaft is engaged with the differential 110. In the first position, the axle shaft is further engaged with the wheel hub (e.g., the flange 204 coupled to the respective wheel hub via the first set of fasteners) and the axle shaft transfers torque to the respective wheel hub. The axle shaft is shown in the second position in FIG. 8.

As shown in FIG. 2, the axle shafts (e.g., the first axle shaft 117, the second axle shaft 115) may each be selectively coupled to a wheel hub (e.g., the first wheel hub 152, the second wheel hub 154, respectively) via the flange 204 of the respective axle shaft. Bolts 206 may extend from each of the first wheel hub 152 and the second wheel hub 154. A respective flange 204 of an axle shaft may be positioned on the wheel hub, such that the bolts 206 extend through the through holes 210 of the flange 204. The respective flange 204 may be selectively coupled to the wheel hub using a first set of fasteners 212, such as nuts, bolts, clip fasteners, or other sufficient fastening elements.

The wheel hubs (e.g., the first wheel hub 152 and the second wheel hub 154) may each be coupled to a brake drum 214, which may house elements of the axle assembly 104 used to slow or halt rotational motion of the drive wheels via respective wheel hubs. The first wheel hub 152 and the second wheel hub 154 may each be fixedly or selectively coupled to the respective brake drum 214, for example, via a second plurality of fasteners 208.

Preparing the axle assembly 104 for vehicle transportation (e.g., via towing) comprises transitioning the axle assembly 104 from the first configuration to a second configuration. In the second configuration, the axle shafts (e.g., the first axle shaft 117, the second axle shaft 115) are disengaged from the differential 110 such that rotation of the wheels (e.g., the first wheel 112, the second wheel 114, not shown in FIG. 2) does not translate to rotation of the differential 110, via the axle shafts. This may assist in reducing degradation of elements of the axle assembly 104, including the axle shafts and the differential 110, due to back driving of the differential 110 when the differential is not being driven by a power source (e.g., the electric machine 106, ICE, etc.).

Conventional methods for disengaging the axle shafts from the differential to prepare the axle assembly of a vehicle for vehicle transport (e.g., towing) may be a time consuming process that demands management of many pieces used to couple the truck to the transport vehicle, as well as management of pieces of the axle assembly of the truck itself. For example, a bolt may be used to engage a differential clutch lock to prevent the clutch from falling out prior to removal of the axle shafts. Fasteners used to couple the axle shafts to the axle assembly 104 (e.g., the first set of fasteners 212) may be retained in or on the vehicle or the transporting vehicle during transportation. The axle shafts (e.g., the first axle shaft 117, the second axle shaft 115) may be laterally translated in a direction away from the differential 110 to uncouple the axle shafts from the differential 110. A cover may be placed over an opening of a wheel hub (e.g., an interface where the flange 204 is coupled to the respective wheel hub) to block contamination from entering the axle shaft and/or preventing axle lubrication from exiting the axle shaft and onto a road/ground surface. The hub cover may be removed and discarded during reassembly of the axle assembly.

Described herein with respect to FIGS. 3-8 is an axle shaft transport retention spacer that may be implemented into an axle assembly, such as the axle assembly 104, to selectively disengage axle shafts of the axle assembly from the differential while retaining the axle shafts in the axle assembly (e.g., not fully removing the axle shafts). FIG. 3 shows a perspective view of an axle shaft transport retention spacer, also referred to herein as an axle shaft spacer 300. The axle shaft spacer 300 comprises a first portion 302 and a second portion 304 configured to be selectively coupled to each other. The axle shaft spacer 300 further comprises a center bore 306 that extends through the first portion 302 and the second portion 304. The center bore 306 is configured to circumferentially surround an axle shaft. The axle shaft spacer 300 may be formed of a rigid material, such as plastic, iron, or aluminum. In some examples, the axle shaft spacer 300 may be coated with a hub seal material and/or a coating that prevents oil, lubricating fluid, and/or other liquids from leaking out of the axle assembly at an interface. The interface may be between the axle shaft spacer 300 and the flange 204 of the first axle shaft 117, and/or between the axle shaft spacer 300 and the first wheel hub 152, as further described with respect to FIG. 8.

In some examples, the first portion 302 and the second portion 304 of the axle shaft spacer 300 are identical (e.g., have the same configuration). A body 320 of each of the first portion 302 and the second portion 304 may comprise one or more concave features 316, each extending from a circumference of the axle shaft spacer 300 towards the center bore 306. In some examples, each of the first portion 302 and the second portion 304 may comprise two concave features 316. In other examples, each of the first portion 302 and the second portion 304 may comprise more than or less than two concave features 316. The concave features 316 are configured to assist in positioning the axle shaft spacer 300 in the axle assembly and, specifically, to position the axle shaft spacer 300 with respect to the wheel hubs (e.g., the first wheel hub 152, the second wheel hub 154). Each concave feature 316 may include a shelf 318 at a second side 340 of the axle shaft spacer 300. Each shelf 318 may have a first height 322, and a through hole 324 extending through the first height 322 of the shelf 318. The through hole 324 may be configured to retain fasteners used to couple the wheel hub to the axle shaft spacer 300. For example, a bolt 206 of the first wheel hub 152 or the second wheel hub 154 may extend through the through hole 324 and into the respective concave feature 316, and a fastener of the first set of fasteners 212 may be coupled to the bolt 206.

In a first example of the axle shaft spacer 300 shown in FIGS. 3, 4, and 7, the first portion 302 and the second portion 304 further include coupling extensions 326 that extend from the body 320 at a first side 330, in between each concave feature 316. The coupling extensions 326 each extend along axes parallel to a center axis 332 of the center bore 306. The coupling extensions 326 may be threaded extensions, such as bolts. The coupling extensions 326 may be used to couple an axle shaft (e.g., the first axle shaft 117, the second axle shaft 115) to the axle shaft spacer 300, as further described with respect to FIG. 8. For example, the coupling extensions 326 may be examples of the bolts 206 described with respect to FIG. 2.

The first portion 302 comprises a first socket 310 and a first pin 308, and the second portion 304 comprises a second pin 312 and a second socket 314 configured to selectively mesh with the first socket 310 and the first pin 308 of the first portion 302, respectively, to selectively couple the first portion 302 and the second portion 304. The first portion 302 and the second portion 304 are coupled to form the axle shaft spacer 300, which is a symmetric unit.

In some examples, the first portion 302 and the second portion 304 may have different coupling configurations. For example, the body 320 of each of the first portion 302 and the second portion 304 may be the same, and elements used to couple the first portion 302 and the second portion 304 to each other may be different. The first portion 302 may comprise a series of sockets (e.g., the first socket 310 and a second socket instead of/in place of the first pin 308), and the second portion 304 may comprise a series of pins (e.g., the second pin 312 and a first pin instead of/in place of the second socket 314). In this example, the series of pins of the second portion 304 are configured to be selectively inserted into the series of sockets of the first portion 302 to selectively couple the first portion 302 and the second portion 304.

FIG. 4 shows a perspective view 400 of the first portion 302 of the axle shaft spacer 300. In some embodiments the first portion 302 and the second portion 304 are identical, thus the description of FIG. 4 also describes the second portion 304. The first pin 308 and the first socket 310 (e.g., the second pin 312 and the second socket 314 in the second portion 304) each extend a second height 422 of the body 320 of the first portion 302. The second height 422 may be less than a total height 420 of the body 320. The first portion 302 further comprises one or more coupling sockets 402. In some examples, the coupling sockets 402 may be in vertical alignment with coupling extensions 326 of the first portion 302. Similar to the through holes 324 extending through the first height of the shelf 318 in the concave features 316, the coupling sockets 402 are configured to retain fasteners used to couple the wheel hub to the axle shaft spacer 300. For example, a bolt 206 of the first wheel hub 152 may extend into the coupling socket 402.

The body 320 of the first portion 302 may be configured as a partial hollow body having a first diameter 404 at the first side 330 and a second diameter 406 at the second side 340, opposite the first side 330. The first diameter 404 may be less than the second diameter 406. The first diameter 404 may be configured to be greater than or equal to a diameter of an axle shaft (e.g., the first axle shaft 117, the second axle shaft 115). Additionally, the first diameter 404 may be less than a diameter of the flange 204 of the axle shaft (e.g., the first axle shaft 117, the second axle shaft 115). In this way, the axle shaft spacer 300 may circumferentially surround an axle shaft. The first side 330 of the axle shaft spacer 300 may be in face-sharing contact with the flange 204 of the first axle shaft 117 and, due to the first diameter 404 being less than the diameter of the flange 204, the axle shaft spacer 300 may be prevented from moving in a further direction towards the flange 204 and/or off of the first axle shaft 117.

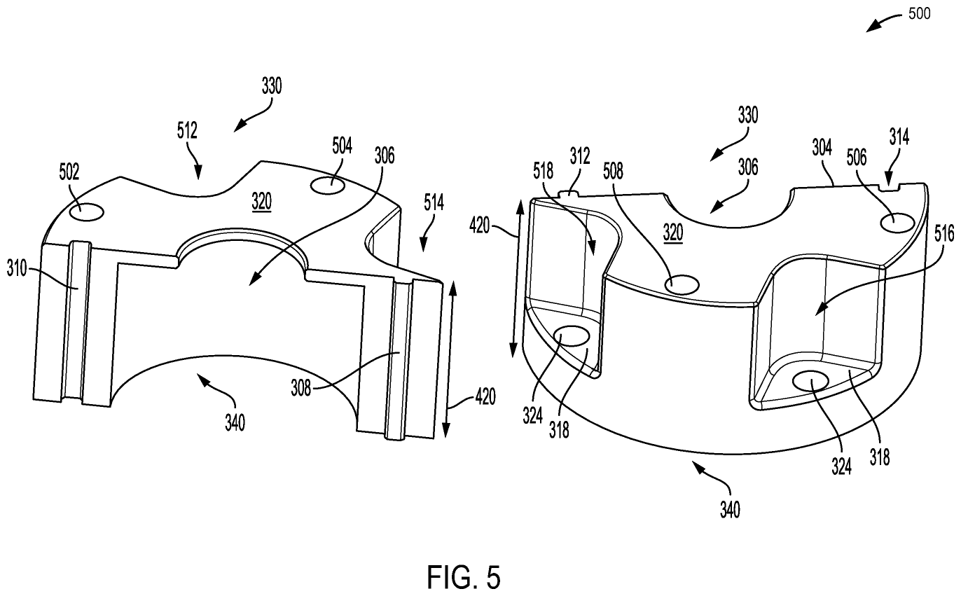

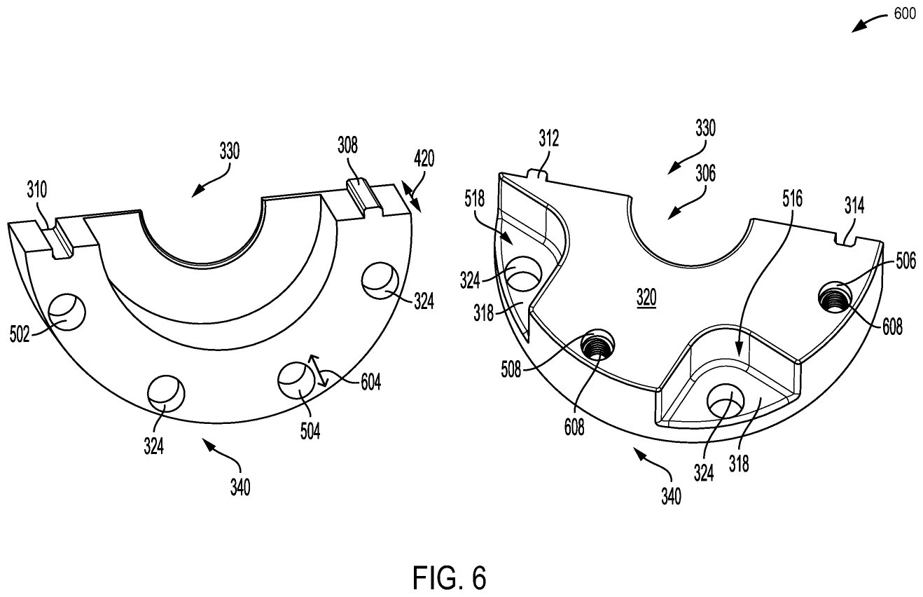

FIG. 5 shows a first set of perspective views 500, and FIG. 6 shows a second set of perspective views 600 of a second example of the first portion 302 and the second portion 304 of the axle shaft spacer 300. Some elements of the second example of the axle shaft spacer 300 are the same as the first example, and are not reintroduced for brevity. In the second example, the first portion 302 and the second portion 304 may not include coupling extensions 326 described with respect to FIGS. 3-4. Instead, the body 320 comprises a second set of coupling sockets positioned in between the concave features 316. For example, a first coupling socket 502 is positioned between the first socket 310 and a first concave feature 512, and a second coupling socket 504 is positioned between the first concave feature 512 and a second concave feature 514. In the second portion 304, a third coupling socket 506 is positioned between the second socket 314 and a third concave feature 516, and a fourth coupling socket 508 is positioned between the third concave feature 516 and a fourth concave feature 518. Each of the first coupling socket 502, the second coupling socket 504, the third coupling socket 506, and the fourth coupling socket 508 (e.g., collectively, the second set of coupling sockets) may extend through the total height 420 of the body 320. In this way, bolts 206 of the wheel hub (e.g., the first wheel hub 152, the second wheel hub 154) may extend through each of the second set of coupling sockets, from the second side 340 to the first side 330. As further described with respect to FIG. 8, the first set of fasteners 212 may be used along with the bolts 206 of the wheel hub to couple the axle shaft spacer 300 to the wheel hub. Additionally, each of the first pin 308, the second pin 312, the first socket 310, and the second socket 314 extend the total height 420 of the body 320.

In another example of the axle shaft spacer 300, the first coupling socket 502, the second coupling socket 504, the third coupling socket 506, and the fourth coupling socket 508 are each configured as coupling sockets 402 and extend a third height 604 of the total height 420 from the second side 340. Each of the second set of coupling sockets may not extend through the total height 420 from the first side 330 to the second side 340. From the second side 340, a coupling extension such as bolts 206 of the first wheel hub 152, may extend into a coupling socket (e.g., the first coupling socket 502). From the second side 340, each of the second set of coupling sockets may have a threaded interior 608 configured to receive a threaded coupling extension. For example, a bolt or other threaded coupling extension may be coupled to the first portion 302 and/or the second portion 304 of the axle shaft spacer 300 at one or more of the first coupling socket 502, the second coupling socket 504, the third coupling socket 506, and the fourth coupling socket 508 on the first side 330. The coupling extensions 326 described with respect to FIGS. 3-4 may be examples of threaded coupling extensions, which may be selectively coupled to the axle shaft spacer 300 in some examples, and fixedly coupled to the axle shaft spacer 300 in other examples.

FIG. 7 shows a perspective view 700 of an example of the axle shaft spacer 300 positioned on a wheel hub, which may be either of the first wheel hub 152 and/or the second wheel hub 154 of FIG. 2. The axle shaft spacer 300 shown in FIG. 7 is the first example of the axle shaft spacer 300 of FIGS. 3-4, though it is to be understood that the second example of the axle shaft spacer 300 of FIGS. 5-6 may be similarly positioned on the wheel hub without departing from the scope of the present disclosure.

Bolts 206 of the first wheel hub 152 may be used to position and retain the axle shaft spacer 300 on the first axle shaft 117 (e.g., not shown in FIG. 7). Bolts 206 may extend into each of the through holes 324 and, when present, into each coupling socket 402 (e.g., described with respect to FIG. 4) or through hole of the second set of coupling sockets (e.g., described with respect to FIGS. 5-6). An example positioning of the through holes 324 and/or the coupling sockets 402 are shown in dashed line 702. As shown in FIG. 7, bolts 206 of the first wheel hub 152 may extend through the first height 322 of the shelf 318 of the body 320 of the axle shaft spacer 300. As further described with respect to FIG. 8, a first set of fasteners 212 may be used to selectively couple the first wheel hub 152 to the axle shaft spacer 300, for example, by threading a nut onto each bolt 206 of the first wheel hub 152, such that the shelf 318 of the axle shaft spacer 300 is held between the nut and the first wheel hub 152.

FIG. 8 shows a partial cross-sectioned view 800 of a second configuration of the axle assembly 104 configured with the axle shaft transport retention spacer 300. Elements of FIGS. 1-7 that are included in FIG. 8 may be similarly numbered and not reintroduced for brevity. The partial cross-sectioned view 800 shows selective coupling of axle shaft spacer 300 to the first axle shaft 117. Though not shown in FIG. 8, it is to be understood that the axle shaft spacer 300 may be selectively coupled to the second axle shaft 115 as described herein with respect to the first axle shaft 117. In some examples, two axle shaft spacers 300 may be included in the second configuration of the axle assembly 104, such that a first axle shaft spacer is positioned on the first axle shaft 117 to uncouple the first axle shaft 117 and the differential 110, and a second axle shaft spacer is positioned on the second axle shaft 115 to uncouple the second axle shaft 115 and the differential 110.

In the second configuration, the first axle shaft 117 is in a second position and is disengaged from the differential 110. The first axle shaft 117 and the second axle shaft 115 are each configured to move laterally in a first direction and a second direction. The first direction is a direction away from the differential 110 (e.g., towards the respective wheel) and the second direction is towards the differential 110 (e.g., away from the respective wheel). As shown in a detailed view 850, the first axle shaft 117 is spaced apart from the differential 110 to provide a gap 852 between the differential 110 and an end 854 of the first axle shaft 117 opposite the flange 204. The gap 852 may have a width of between four inches and five inches, for example. In this way, rotational motion of the first axle shaft 117 is not transferred to the differential 110 (e.g., the differential is not back driven), which may reduce degradation of the differential 110 during towing of a vehicle configured with the axle assembly 104 in the second configuration.

The first axle shaft 117 is disengaged from the differential 110 by engaging the first axle shaft with the axle shaft spacer 300. The first axle shaft 117 is engaged with the axle shaft spacer 300 at the flange 204 of the first axle shaft 117. For example, coupling extensions 326 of the first portion 302 and the second portion 304 of the axle shaft spacer 300 may extend through the plurality of through holes 210 of the flange 204. The first set of fasteners 212 may be selectively coupled to the coupling extensions 326 to couple the flange 204 to the axle shaft spacer 300. In an example of the axle shaft spacer 300 that does not include the coupling extensions 326 and is instead configured with the second set of coupling sockets described with respect to FIGS. 4 and 5, bolts 206 of the first wheel hub 152 may extend through the second set of coupling sockets in addition to through the through holes 324 of the shelf 318. The first set of fasteners 212 may be selectively coupled to the bolts 206 to couple the flange 204 to the axle shaft spacer 300.

The center bore 306 of the axle shaft spacer 300 circumferentially surrounds the first axle shaft 117. A diameter 802 of the flange 204 of the first axle shaft 117 is greater than the first diameter 404 of the body 320 of the first portion 302 of the axle shaft spacer 300. When the first portion 302 and the second portion 304 of the axle shaft spacer 300 are coupled to each other and positioned on the first axle shaft 117 as shown in FIG. 8, the first axle shaft 117 may be prevented from moving in a second direction, indicated by a second arrow 804, towards the differential 110. The axle shaft spacer 300 is further coupled to the first wheel hub 152 as described with respect to FIG. 7. When in the second position, rotational motion experienced by the first wheel hub 152 (e.g., from the first wheel 112 mounted thereon being driven along a drive surface) is not transferred to the differential 110, due to the first axle shaft 117 being disconnected from the differential 110. The axle shaft spacer 300 may be coated with a hub seal material and/or coating that prevents oil, lubricating fluid, or other liquids from leaking out of the axle assembly at a first interface 806 between the axle shaft spacer 300 and the flange 204 of the first axle shaft 117, and/or at a second interface 808 between the axle shaft spacer 300 and the first wheel hub 152.

Transitioning the first axle shaft 117 of the axle assembly 104 from the first configuration (e.g., shown in FIG. 2) to the second configuration (e.g., shown in FIG. 8) comprises: removing the first set of fasteners 212 that selectively couple the flange 204 of the first axle shaft 117 and the first wheel hub 152, laterally translating the first axle shaft 117 in the first direction, indicated by a first arrow 810, to disengage the first axle shaft 117 from the differential 110, positioning and selectively coupling the first portion 302 and the second portion 304 of the axle shaft spacer 300 to circumferentially surround the first axle shaft 117 between the flange 204 and the first wheel hub 152, laterally translating the first axle shaft 117 in the second direction, opposite the first direction, to engage the flange 204 of the first axle shaft 117 and the axle shaft spacer 300 in face-sharing contact and disengage the first axle shaft 117 from the differential 110, and coupling the axle shaft spacer 300 to the flange 204 using the first set of fasteners 212. The second axle shaft 115 of the axle assembly 104 may be transitioned from the first configuration to the second configuration by applying the same method to respective elements of the second axle shaft 115 and the second wheel hub 154.

FIG. 9 shows a flow chart of a method 900 for vehicle transportation and, specifically, for preparing an axle assembly of a vehicle for transportation via towing by uncoupling an axle shaft from a differential of the axle assembly using an axle shaft transport retention spacer. The vehicle may be coupled to a transport vehicle in such a way that one or more wheels of the vehicle are not in contact with the driving surface. The vehicle is not moved under its own power (e.g., the electric machine, ICE, and/or other power source of the vehicle is not used to drive rotation of the wheels). The axle assembly having wheels in contact with the driving surface may have the method 900 applied thereto to disengage the differential from the axle shafts of the axle assembly, such that rotation of wheels in contact with the drive surface does not translate to rotation of the differential. The method 900 is described with respect to the axle assembly 104 and the axle shaft transport retention spacer 300 of FIGS. 2-8.

At 902, the method 900 comprises removing a first set of fasteners that selectively couple a flange of an axle shaft, and a wheel hub. The first set of fasteners may be selectively coupled to bolts of the wheel hub, and may include studs, nuts, clip fasteners, or other types of selective fasteners. The first set of fasteners may be removed by a user (e.g., by hand) and/or using an additional tool, such as a wrench.

At 904, the method 900 comprises laterally translating the axle shaft in a first direction to disengage the axle shaft from a differential. In some examples, the axle shaft may be laterally translated to provide a physical gap between the differential and an end of the axle shaft opposite the flange of the axle shaft. For example, the physical gap may be four inches wide. Splines of the axle shaft may be disengaged from (e.g., unmeshed with) the differential.

At 906, the method 900 comprises positioning and selectively coupling a first portion and a second portion of an axle shaft transport retention spacer to circumferentially surround the axle shaft between the flange of the axle shaft and the wheel hub. Selectively coupling the first portion and the second portion of the axle shaft transport retention spacer includes engaging coupling elements to each other. For example, the first portion and the second portion may have an identical configuration and coupling the first portion and the second portion may include selectively meshing a first socket and a first pin of the first portion with a second pin and a second socket of the second portion, respectively. In other examples, the first portion and the second portion may have different configurations, and coupling the first portion and the second portion may include selectively meshing a first pin and a second pin of the first portion with a first socket and a second socket of the second portion.

At 908, the method 900 comprises laterally translating the axle shaft in a second direction, opposite the first direction, to position the flange of the axle shaft on the axle shaft spacer. This may include inserting coupling extensions of the axle shaft spacer, and/or bolts of the wheel hub that extend through the second set of coupling sockets of the axle shaft spacer, into through holes of the flange. This may further include positioning the flange in face-sharing contact with the axle shaft spacer.

At 910, the method 900 comprises coupling the axle shaft transport retention spacer to the flange of the axle shaft using the first set of fasteners. For example, the first set of fasteners may be threaded onto the coupling extensions of the axle shaft spacer, and/or bolts of the wheel hub that extend through the second set of coupling sockets of the axle shaft spacer, that extend into through holes of the flange. The method 900 ends.

The vehicle may thus be prepared for transportation. For example, the vehicle may be coupled to/towed by another vehicle, where drive wheels of the axle assembly prepared using the method 900 are in contact with a drive surface. The axle shaft may be disengaged from the differential for the duration of vehicle transport, and may be prevented from reengaging with the differential (e.g., prevented from moving in the second direction) while the axle shaft spacer is positioned on the axle shaft. When the axle shaft is disengaged from the differential, rotation of a wheel mounted on a wheel hub does not transfer rotation to the differential via the axle shaft, preventing back driving of the differential by the axle shaft. In this way, degradation of the differential, the axle shaft, and other elements of the axle assembly due to back driving during vehicle transportation may be reduced. Additionally, the method 900 provides a simplified method for vehicle transportation compared to conventional methods, and does not demand removal and storage of the axle shaft from the axle shaft assembly.

Following arrival of the vehicle at a target destination, the axle assembly of the vehicle with the axle shaft spacer implemented therein may be reconfigured to a drive configuration where the differential is coupled to and configured to rotationally drive the axle shafts. FIG. 10 shows a flow chart of a method 1000 for vehicle transportation and, specifically, for reassembling the axle assembly by removing the axle shaft spacer and engaging the axle shaft with the differential.

At 1002, the method 1000 includes removing a first set of fasteners that selectively couple the axle shaft transport retention spacer to the flange of the axle shaft. For example, the first set of fasteners may be removed from the coupling extensions of the axle shaft spacer, and/or bolts of the wheel hub that extend through the second set of coupling sockets of the axle shaft spacer, that extend into through holes of the flange.

At 1004, the method 1000 includes laterally translating the axle shaft in the first direction to disengage the flange of the axle shaft from the axle shaft spacer. This may increase a size of the gap between the axle shaft and the differential, and may provide a gap between the flange of the axle shaft and the axle shaft spacer. Further, coupling extensions of the axle shaft spacer and/or bolts of the wheel hub that extend through the second set of coupling sockets of the axle shaft spacer may be removed from the through holes of the flange.

At 1006, the method 1000 includes uncoupling and removing the first portion and the second portion of the axle shaft transport retention spacer from the axle shaft. Uncoupling the first portion and the second portion of the axle shaft transport retention spacer includes disengaging coupling elements (e.g., the first pin and the second socket, the second pin and the first socket) from each other.

At 1008, the method 1000 includes laterally translating the axle shaft in a second direction to engage the axle shaft with the differential and with the wheel hub. The second direction is opposite the first direction as described in the method 900 and with respect to FIG. 8. Engaging the axle shaft with the differential may include engaging splines of the axle shaft with the differential, and enables the differential to provide rotational motion to the axle shaft. Engaging the axle shaft with the wheel hub positioning bolts of the wheel hub in through holes of the flange of the axle shaft. In this way, rotational motion may be provided from the differential to a drive wheel mounted on the wheel hub via the axle shaft.

At 1010, the method 1000 includes coupling the axle shaft to the wheel hub via the first set of fasteners. The first set of fasteners may be selectively coupled to bolts of the wheel hub, and may include studs, nuts, clip fasteners, or other types of selective fasteners. The first set of fasteners may be coupled a user (e.g., by hand) and/or using an additional tool, such as a wrench. The method 1000 ends. The vehicle may thus be prepared for self-propelled driving.

The technical effect of the axle shaft transport retention spacer is that axle assemblies may be configured to disengage axle shafts from the differential in such a way that a strength, rigidity, and resistance to stress-based degradation of the axle assembly increased compared to conventional axle assembly configurations during vehicle transport that may include removal of axle shafts from the axle assembly. A useable lifespan of the differential, axle shafts, and other elements of the axle assembly may be increased. Further, a usability of the axle assembly is increased, as the method for preparing the axle assembly for vehicle transport does not demand management of multiple, small, and/or heavy elements.

The disclosure also provides support for an axle shaft transport retention spacer, comprising: a first portion and a second portion configured to be selectively coupled to each other, and a center bore that extends through the first portion and the second portion and that is configured to circumferentially surround an axle shaft. In a first example of the system, the axle shaft transport retention spacer is formed of plastic, iron, or aluminum. In a second example of the system, optionally including the first example, the axle shaft transport retention spacer is coated with a hub seal material and/or coating. In a third example of the system, optionally including one or both of the first and second examples, each of the first portion and the second portion include a plurality of through holes configured to retain fasteners. In a fourth example of the system, optionally including one or more or each of the first through third examples, the first portion and the second portion are identical. In a fifth example of the system, optionally including one or more or each of the first through fourth examples, the first portion comprises a series of sockets and the second portion comprises a series of pins configured to be selectively inserted into the series of sockets of the first portion to selective couple the first portion and the second portion. In a sixth example of the system, optionally including one or more or each of the first through fifth examples, the first portion comprises a first socket and a first pin, and the second portion comprises a second pin and a second socket configured to selectively mesh with the first socket and the first pin of the first portion, respectively, to selective couple the first portion and the second portion. In a seventh example of the system, optionally including one or more or each of the first through sixth examples, the system further comprises: a series of concave features about a circumference of the first portion and the second portion, the series of concave features extending towards the center bore of the axle shaft transport retention spacer. In an eighth example of the system, optionally including one or more or each of the first through seventh examples, the system further comprises: a series of coupling extensions extending from a face of the axle shaft transport retention spacer along an axis parallel to a center axis of the center bore.

The disclosure also provides support for a method for vehicle transportation, comprising: removing a first set of fasteners that selectively couple a flange of an axle shaft and a wheel hub, laterally translating the axle shaft in a first direction to disengage the axle shaft from a differential, positioning and selectively coupling a first portion and a second portion of an axle shaft transport retention spacer to circumferentially surround the axle shaft between the flange of the axle shaft and the wheel hub, laterally translate the axle shaft in a second direction, opposite the first direction, to position the flange of the axle shaft on the axle shaft transport retention spacer, and couple the axle shaft transport retention spacer to the flange of the axle shaft using the first set of fasteners. In a first example of the method, rotation of a wheel mounted on the wheel hub does not transfer rotation to the differential via the axle shaft. In a second example of the method, optionally including the first example, laterally translating the axle shaft away from the differential includes laterally translating the axle shaft to provide a gap between the differential and an end of the axle shaft opposite the flange of the axle shaft. In a third example of the method, optionally including one or both of the first and second examples, selectively coupling the first portion and the second portion of the axle shaft transport retention spacer comprises selectively meshing a first socket and a first pin of the first portion with a second pin and a second socket of the second portion, respectively. In a fourth example of the method, optionally including one or more or each of the first through third examples, the method further comprises: coupling the axle shaft transport retention spacer to the wheel hub via a second set of fasteners. In a fifth example of the method, optionally including one or more or each of the first through fourth examples, the method further comprises: removing the first set of fasteners that selectively couple the axle shaft transport retention spacer to the flange of the axle shaft, laterally translating the axle shaft in the first direction to disengage the flange of the axle shaft from the axle shaft transport retention spacer, uncoupling and removing the first portion and the second portion of the axle shaft transport retention spacer from the axle shaft, laterally translating the axle shaft in the second direction to engage the axle shaft with the differential and with the wheel hub, and coupling the axle shaft to the wheel hub via the first set of fasteners.

The disclosure also provides support for an axle assembly, comprising: an axle shaft configured to translate along an axis between a first position and a second position, a wheel hub selectively coupled to the axle shaft, and an axle shaft spacer selectively coupled to the wheel hub and the axle shaft, wherein the axle shaft is configured to transfer torque to the wheel hub when in the first position and coupled to the wheel hub and wherein the axle shaft does not transfer torque to the wheel hub when in the second position and coupled to the axle shaft spacer. In a first example of the system, in the first position the axle shaft is engaged with a differential and in the second position the axle shaft is disengaged from the differential. In a second example of the system, optionally including the first example, the axle shaft spacer comprises: a first portion of the axle shaft spacer and a second portion of the axle shaft spacer, where the first portion and the second portion are configured to be selectively coupled to each other, and a center bore that extends through the first portion and the second portion and is configured to circumferentially surround the axle shaft. In a third example of the system, optionally including one or both of the first and second examples, the axle shaft spacer is coupled to the axle shaft at a flange of the axle shaft via a first set of fasteners and the axle shaft spacer is coupled to the wheel hub via bolts of the wheel hub, wherein the first set of fasteners couple the wheel hub to the axle shaft when the axle shaft is in the first position. In a fourth example of the system, optionally including one or more or each of the first through third examples, the first set of fasteners include one or more bolts, studs, and nuts.

FIGS. 1-8 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An axle shaft transport retention spacer, comprising:
a first portion and a second portion configured to be selectively coupled to each other; and
a center bore that extends through the first portion and the second portion and that is configured to circumferentially surround an axle shaft.

2. The axle shaft transport retention spacer of claim 1, wherein the axle shaft transport retention spacer is formed of plastic, iron, or aluminum.

3. The axle shaft transport retention spacer of claim 1, wherein the axle shaft transport retention spacer is coated with a hub seal material and/or coating.

4. The axle shaft transport retention spacer of claim 1, wherein each of the first portion and the second portion include a plurality of through holes configured to retain fasteners.

5. The axle shaft transport retention spacer of claim 1, wherein the first portion and the second portion are identical.

6. The axle shaft transport retention spacer of claim 1, wherein the first portion comprises a series of sockets and the second portion comprises a series of pins configured to be selectively inserted into the series of sockets of the first portion to selective couple the first portion and the second portion.

7. The axle shaft transport retention spacer of claim 1, wherein the first portion comprises a first socket and a first pin, and the second portion comprises a second pin and a second socket configured to selectively mesh with the first socket and the first pin of the first portion, respectively, to selective couple the first portion and the second portion.

8. The axle shaft transport retention spacer of claim 1, further comprising a series of concave features about a circumference of the first portion and the second portion, the series of concave features extending towards the center bore of the axle shaft transport retention spacer.

9. The axle shaft transport retention spacer of claim 1, further comprising a series of coupling extensions extending from a face of the axle shaft transport retention spacer along an axis parallel to a center axis of the center bore.

10. A method for vehicle transportation, comprising:
removing a first set of fasteners that selectively couple a flange of an axle shaft and a wheel hub;
laterally translating the axle shaft in a first direction to disengage the axle shaft from a differential;
positioning and selectively coupling a first portion and a second portion of an axle shaft transport retention spacer to circumferentially surround the axle shaft between the flange of the axle shaft and the wheel hub;
laterally translate the axle shaft in a second direction, opposite the first direction, to position the flange of the axle shaft on the axle shaft transport retention spacer; and
couple the axle shaft transport retention spacer to the flange of the axle shaft using the first set of fasteners.

11. The method of claim 10, wherein rotation of a wheel mounted on the wheel hub does not transfer rotation to the differential via the axle shaft.

12. The method of claim 10, wherein laterally translating the axle shaft away from the differential includes laterally translating the axle shaft to provide a gap between the differential and an end of the axle shaft opposite the flange of the axle shaft.

13. The method of claim 10, wherein selectively coupling the first portion and the second portion of the axle shaft transport retention spacer comprises selectively meshing a first socket and a first pin of the first portion with a second pin and a second socket of the second portion, respectively.

14. The method of claim 10, further comprising coupling the axle shaft transport retention spacer to the wheel hub via a second set of fasteners.

15. The method of claim 10, further comprising:
removing the first set of fasteners that selectively couple the axle shaft transport retention spacer to the flange of the axle shaft;
laterally translating the axle shaft in the first direction to disengage the flange of the axle shaft from the axle shaft transport retention spacer;
uncoupling and removing the first portion and the second portion of the axle shaft transport retention spacer from the axle shaft;
laterally translating the axle shaft in the second direction to engage the axle shaft with the differential and with the wheel hub; and
coupling the axle shaft to the wheel hub via the first set of fasteners.

16. An axle assembly, comprising:
an axle shaft configured to translate along an axis between a first position and a second position;
a wheel hub selectively coupled to the axle shaft; and
an axle shaft spacer selectively coupled to the wheel hub and the axle shaft, wherein the axle shaft is configured to transfer torque to the wheel hub when in the first position and coupled to the wheel hub and wherein the axle shaft does not transfer torque to the wheel hub when in the second position and coupled to the axle shaft spacer.

17. The axle assembly of claim 16, wherein in the first position the axle shaft is engaged with a differential and in the second position the axle shaft is disengaged from the differential.

18. The axle assembly of claim 16, wherein the axle shaft spacer comprises:
a first portion of the axle shaft spacer and a second portion of the axle shaft spacer, where the first portion and the second portion are configured to be selectively coupled to each other; and
a center bore that extends through the first portion and the second portion and is configured to circumferentially surround the axle shaft.

19. The axle assembly of claim 16, wherein the axle shaft spacer is coupled to the axle shaft at a flange of the axle shaft via a first set of fasteners and the axle shaft spacer is coupled to the wheel hub via bolts of the wheel hub, wherein the first set of fasteners couple the wheel hub to the axle shaft when the axle shaft is in the first position.

20. The axle assembly of claim 19, wherein the first set of fasteners include one or more bolts, studs, and nuts.
